(19) United States
(12) Patent Application Publication
(10) Pub. No.: US 2026/0299815 A1
(43) Pub. Date: Oct. 1, 2026

(54) TERMINAL DEVICE AND METHOD FOR UNRECOVERABLY DELETING DATA BY USING SAME

(71) Applicant: JONG SUNG PARK, Gyeonggi-do (KR)

(72) Inventor: JONG SUNG PARK, Gyeonggi-do (KR)

(21) Appl. No.: 18/996,334

(22) PCT Filed: Aug. 3, 2023
(86) PCT No.: PCT/KR2023/011402

§ 371 Date: Jan. 17, 2025

(30) Foreign Application Priority Data
Aug. 9, 2022 (KR) 10-2022-0099064

(51) Int. Cl. G06F 3/06

(52) U.S. Cl. CPC G06F 3/0652; G06F 3/0623; G06F 3/0673; G06F 2212/1052

(57) ABSTRACT

In a method of unrecoverably deleting data stored in a sector of a hard disc or a page of a solid state drive (SSD), allocation information allocated to the data stored in the sector of the hard disc or the page of the SSD is deleted, and a data area is overwritten with a predetermined character. When data stored on a hard disc or an SSD is detected, not only allocation information is deleted but also data to be deleted is overwritten with predetermined data such as characters, so that the data to be deleted cannot be restored, whereby risk of data exposure can be prevented.

### BACKGROUND

### 1. Technical Field

The present invention relates to a terminal device and a method for unrecoverably deleting data by using same, and more specifically, to a terminal device and a method for unrecoverably deleting data by using the terminal device, which are technologies for deleting, without using a physical scheme, data stored on a hard disc or a solid-state drive (SSD) so that the data cannot be recovered.

### 2. Background Art

In the current mature information age, almost all people are using computers and tablets.

These computers and tablets have storage spaces for storing operating systems to run devices and users' personal information data.

Such storage devices use floppy disks and hard discs in the computers and often use flash memories in the tablets.

However, the floppy disks are currently almost obsolete due to the limitations of storage space and the slow read/write speeds. As the storage capacity increases, the hard discs tend to decrease in the read and write speeds, and this results in a growing trend to use solid state drives (SSDs) formed by clustering multiple flash memories solely for the operating systems.

In general, the storage capacities of the hard discs and the SSDs are fixed, and users need to delete dispensable data from the hard discs or the SSDs when a lot of data is stored. However, in a case where data is deleted, the data is not physically removed completely, but only allocation information for a space where the data is stored is deleted. Hence, the space is recognized as an empty space in a file system of a computer operating system, but intact data remains in reality.

Hence, if users believe that data has been completely deleted and have discarded computers or tablets, a third party can acquire the computers or tablets, recover allocation information by using a predetermined data recovery program, and completely recover the data.

Currently, there is no method of unrecoverably deleting data without using a physical scheme such as physical destruction of the disks.

### SUMMARY

In order to solve such problems, an object of the present invention is to provide a terminal device and a method for unrecoverably deleting data using the terminal device, which are technologies for deleting, without using a physical scheme, data stored on a hard disc or a solid-state drive (SSD) so that the data cannot be recovered.

A terminal device according to a characteristic of the present invention to achieve the object includes:
user mode in which an application program is implemented; kernel mode in which an operating system is implemented; and hardware.

In the kernel mode, a simple deletion scheme of deleting allocation information of a file by receiving a request for file deletion processing through a system call from Application 1 which is an application program is executed.

In the kernel mode, a complete deletion scheme of adding a user system call for data deletion, deleting allocation information of a file by receiving a request for file deletion processing through the user system call from Application 2 which is an application program, and unrecoverably deleting the file by overwriting a data area with a predetermined character is executed.

In a method for unrecoverably deleting data using the terminal device according to the characteristic of the present invention,
the data stored in a sector of a hard disc or a page of a solid-state drive (SSD) is unrecoverably deleted by deleting allocation information allocated to the data stored in the sector of the hard disc or the page of the SSD and overwriting a data area with a predetermined character.

According to the above-described configuration, the present invention is effective in that when data stored on a hard disc or an SSD is detected, not only allocation information is deleted but also data to be deleted is overwritten with predetermined data such as characters, so that the data to be deleted cannot be recovered, whereby risk of data exposure can be prevented.

### BRIEF DESCRIPTION OF THE DRAWINGS

FIG. 1 is a view illustrating a structure of a hard disc.

FIG. 2 is a diagram illustrating details of an information recording area of the hard disc.

FIG. 3 is a diagram illustrating an information recording area of an SSD.

FIG. 4 is a diagram illustrating a comparison between the information recording areas of the hard disc and the SSD.

FIGS. 5A to 5D are diagram illustrating storage and deletion of data and allocation information of the data in and from sectors of the hard disc according to a method.

FIG. 6 is a diagram illustrating storage and deletion of data and allocation information of the data according to the present invention.

FIG. 7 is a diagram illustrating file management of an operating system according to the embodiment of the present invention.

FIG. 8 is a diagram illustrating an example in which a delete menu is configured of a context menu according to the embodiment of the present invention.

### DETAILED DESCRIPTION

In the entire specification, when a certain part “comprises” a certain configurational element, this means that another configurational element is not excluded but the other configurational element can be further included unless otherwise specified herein.

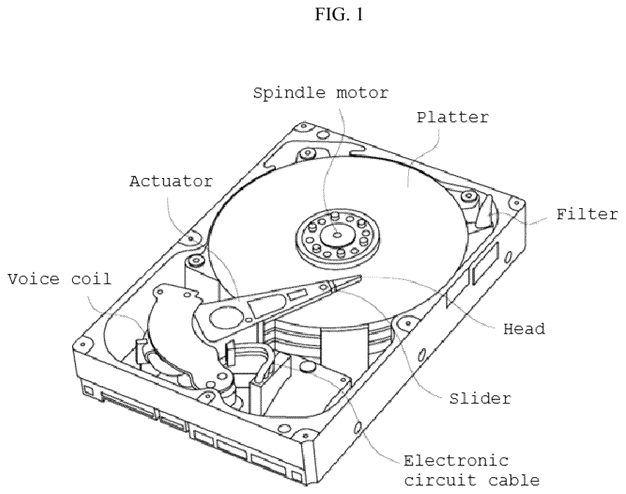

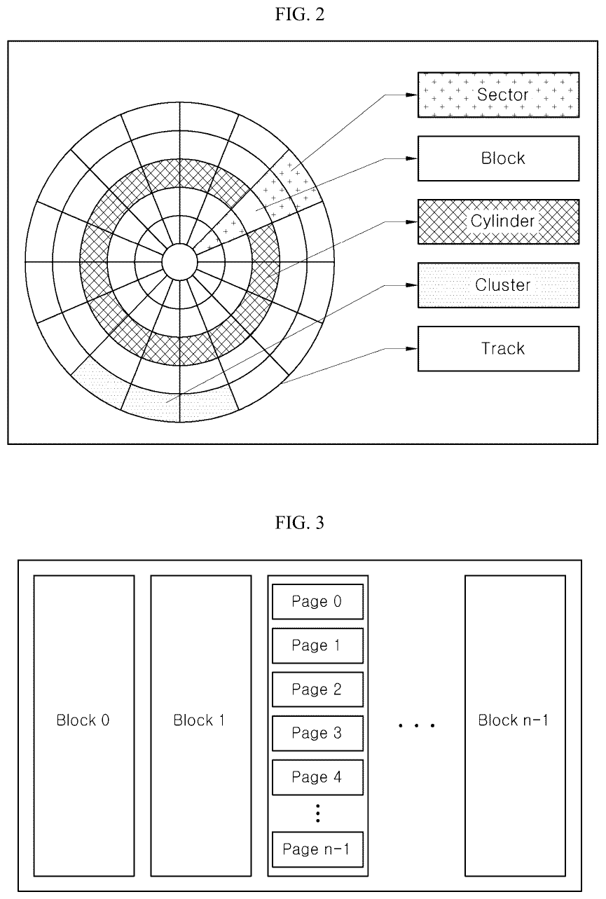

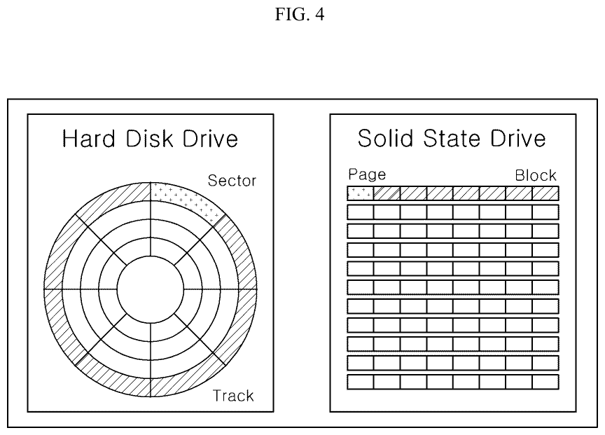

FIG. 1 is a view illustrating a structure of a hard disc, FIG. 2 is a diagram illustrating details of an information recording area of the hard disc, FIG. 3 is a diagram illustrating an information recording area of an SSD, and FIG. 4 is a diagram illustrating a comparison between the information recording areas of the hard disc and the SSD.

As illustrated in FIG. 1, a hard disc 180 is a storage device used in a computer and includes various components, and the most important thereof are a header used to read or write data and a platter where the data is stored.

Depending on the storage capacity of the hard disc 180, one platter is used or multiple platters are used.

A structure of the platter where the data is stored is schematically illustrated in FIG. 2.

The platter is configured to store data by coating a glass or aluminum alloy with a magnetic material. The platter can be largely divided into tracks, sectors, and cylinders.

The tracks are formed in concentric circles on which data is recorded, around a rotation axis on a platter surface, and the hard disc 180 has multiple tracks.

The sectors are sections formed by dividing the track by a certain size, and each sector is a unit of information recording. Data is stored in these sectors. The sectors have storage capacities that further increase as the sectors are positioned outward in the circles. Small data is stored in a single sector, and large data is divided and stored in multiple sectors. At this point, the large data can be stored in a series of consecutive sectors, but can be moved to other locations to be stored in a case where the large data cannot be stored in consecutive sectors.

FIG. 3 is a diagram illustrating a data storage structure of a solid-state drive (SSD).

The SSD includes multiple blocks, and each of these blocks includes multiple pages. Data is stored in the blocks.

As can be found in comparison between storage structures of the hard disc 180 and the SSD illustrated in FIG. 4, the tracks of the hard disc 180 correspond to the blocks of the SSD, and the sectors correspond to the pages. The data is stored in the pages.

In a conventional writing method, the data is written in the sectors through the header in the case of the hard disc 180, and is electronically written in the pages in the case of the SSD. In the case of reading, data is retrieved from the sectors or the pages corresponding to allocation information in a file.

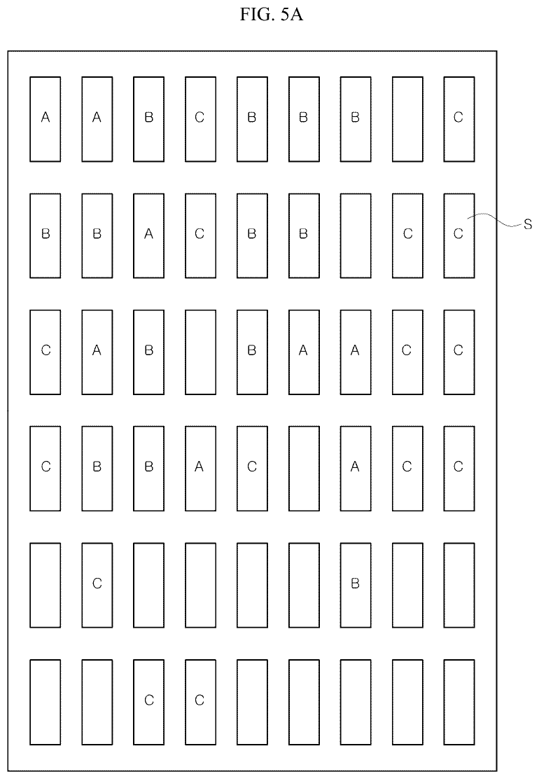

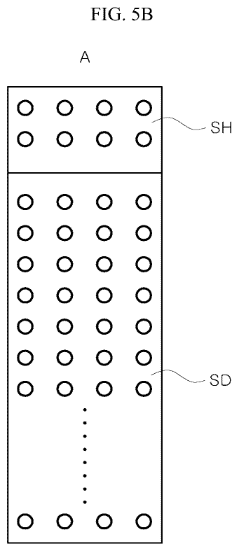

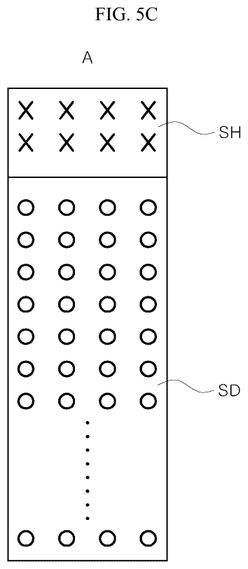

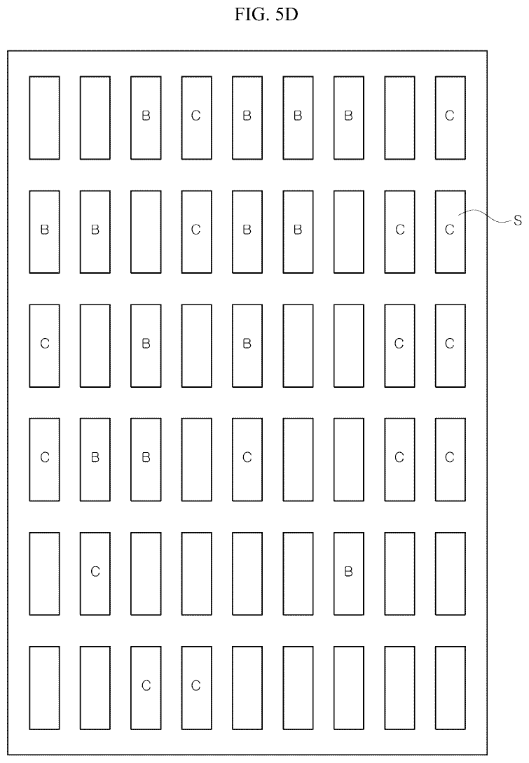

FIGS. 5A to 5D are diagram illustrating storage and deletion of data and the allocation information of the data in and from the sectors of the hard disc 180 according to a conventional method.

FIG. 5A is a diagram illustrating a state in which files named A, B, and C are stored in sectors S of the hard disc 180. As shown in FIG. 5A, each of the sectors S generally has a size of 512 bytes, and a small file can be stored sufficiently in one sector.

However, in a case where a file size is larger than 512 bytes, data is stored in multiple sectors. In this case, the data is not stored in consecutive sectors, but is divided and stored in random sectors. Hence, as shown in FIG. 5A, the A, B, C files are stored unsystematically in the multiple sectors.

FIG. 5B illustrates a sector in which data of a file named A is stored, and the sector can be divided into a header SH in which allocation information for the A file is recorded and a data record section SD in which the data of the A file is recorded. In other words, items of allocation information for the A files are recorded in the headers SH of all the sectors in which the data of the A file is stored, and items of data of the A files are consecutively recorded in data record sections SD thereof. Hence, in a case where the A files are retrieved from the hard disc 180, the items of the allocation information for the A files are read from the sectors, and the items of the data are consecutively retrieved.

As described above, in a case where items of data for specific files are stored in sectors, and the specific files (such as the A files) are desired to be deleted, only the items of the allocation information for the files recorded in the headers SH of the sectors S are deleted (overwritten).

FIG. 5C illustrates a sector S in which the A file has been deleted, in which only the allocation information for the A file recorded in the header SH is deleted, while the data of the A file recorded in the data record section SD is not physically deleted.

In other words, as shown in FIG. 5D, the computer recognizes, as empty spaces, the sectors occupied by the A files, but in reality, the items of the data of the A files stored in the data record sections SD are not deleted, and the A files can be recovered through a predetermined restoration or recovery program later (into the same state as that of FIG. 5A).

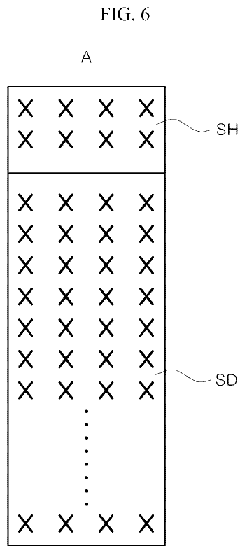

FIG. 6 is a diagram illustrating storage and deletion of data and allocation information of the data according to the present invention.

FIG. 6 illustrates the deletion of data according to the present invention, in which the deletion (overwriting) is executed not only on the header SH of the sector S but also on the data record section SD, thereby deleting all data stored in the sector, making it impossible to restore the A files in reality even through a restoration program later.

In the case of deletion, the data stored in the sectors of the hard disc 180 or the pages of the SSD is not completely deleted, but only the items of the allocation information corresponding to the files and items of file information in physical file areas in an FAT (file allocation table) are deleted, thereby making the sectors or the pages occupied by the files look as empty spaces. In other words, the files look deleted to the user, but the data areas are not physically deleted. Hence, if a predetermined recovery program is used, the files that a user thought had been deleted can be recovered.

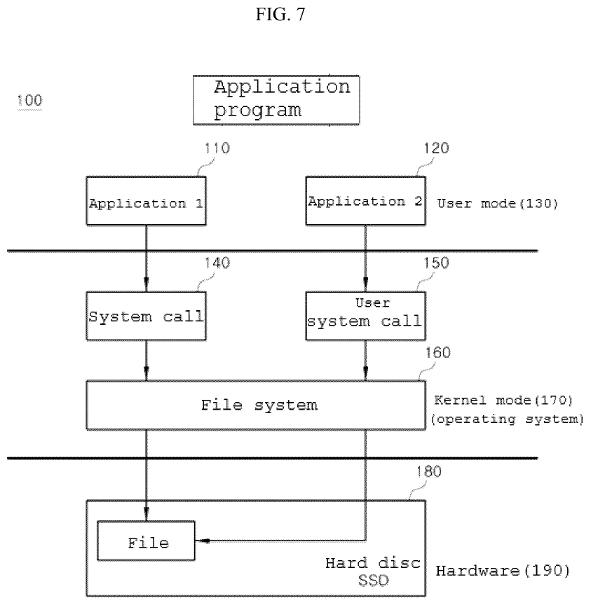

FIG. 7 is a diagram illustrating file management of an operating system according to the embodiment of the present invention.

A terminal device 100 includes user mode 130 in which an application program is implemented, kernel mode 170 in which the operating system is implemented, and hardware 190. Here, the terminal device 100 can include various electronic devices such as a computer device and a smartphone.

The application programs are programs that are executed on the operating system, and the operating system is divided into the user mode 130 in which the application programs are executed and the kernel mode 170 in which the operating system is executed. Here, examples of the operating system can include Android, iOS, Windows, Symbian, Tizen, Linux, Bada, and the like and are not limited to these systems. In the operating system of the present invention, Windows will be used as an example for the convenience of description.

The application programs can refer to programs that operate in a user address space, that is, the user mode 130. The hard disc is a hardware device that serves as a storage medium. The hard disc is controlled by a file system 160 of the operating system, and the application programs can access the hard disc through the file system 160 by calling a system call 140. In other words, the application programs enable a file operation such as creation, deletion, updating, and moving of a file within the hard disc to be performed.

The hard disc is formatted with a file system structure such as FAT32 and NTFS and stores a user file. In particular, the file system 160 has a directory structure with a hierarchical structure and is formed in a hierarchical folder format.

The operating system can correspond to the kernel mode 170. According to various embodiments of the present invention, the operating system includes a system call interface and the file system 160.

The system call 140 is an interface that enables an application program of the user mode 130 to use a function of the operating system of the kernel mode 170, and can provide a function of enabling at least one process to access the hardware 190.

The system call 140 is an interface that allows a service provided by a kernel of the operating system to access the kernel in response to a request from the application program.

When the user mode 130 requests the system call 140, control is transmitted to the kernel mode 170 (from the user mode 130 to the kernel mode 170). In the kernel mode 170, a function table is present.

In the kernel mode 170, a unique number (function number) is allocated for each function so that the individual system calls 140 are internally distinguished, and service routines corresponding to functions in the function table are defined inside a kernel by using the unique numbers as indexes.

In the kernel mode 170, the unique number corresponding to the requested system call 140 is checked.

In the kernel mode 170, service routines in accord with the unique number are called, the service routines are all processed, and then mode switch is performed from the kernel mode 170 back to the user mode 130.

The service routine includes an I/O service, a device driver, the file system 160, a system service, and exceptional handling.

The file system 160 can perform file creation, file deletion, opening, closing, reading, writing, repositioning, and obtaining and setting of a file property.

According to the present invention, there is provided a method for unrecoverably deleting a file that has been deleted in the file system 160 of a computer operating system.

The file system 160 can be different in a management method depending on the operating system, but can store both information of a file and storage location information for storing data in an auxiliary storage device.

The file system 160 manages a file by using the file allocation table (FAT) and a new technology file system (NTFS). For reference, Unix (including Linux) manages a file with a concept of a super node and an inode.

The management (creation, writing, moving, or deletion) of a file in the operating system is performed through registering, modifying, and deleting information of a file in the FAT, the NTFS, the super node, or the inode. The information of the file includes physical location information, and the management of the file is operated in the kernel mode 170.

The management (creation, writing, moving, or deletion) of a file in the application is performed by requesting file processing to the kernel mode 170 through the system call 140 and executing the file processing on the hard disc in the file system 160 in the kernel mode 170.

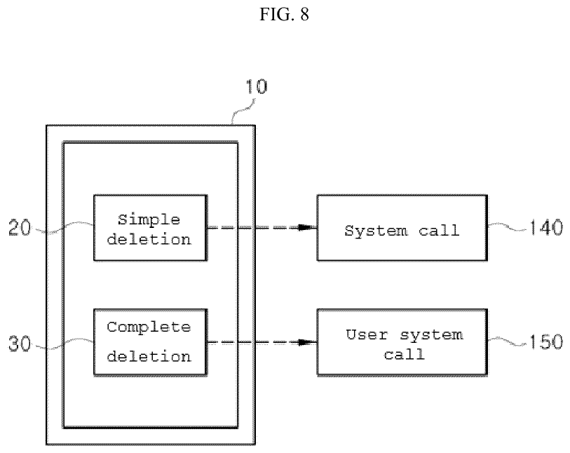

FIG. 7 is a diagram illustrating the file management of the operating system according to the embodiment of the present invention, and FIG. 8 is a diagram illustrating an example in which a delete menu is configured of a context menu 10 according to the embodiment of the present invention.

FIG. 7 illustrates file management that is performed by Application 1 110 through a conventional file deletion method.

The Application 1 110 requests file deletion processing to the kernel mode 170 through the system call 140. In the file system 160 in the kernel mode 170, the deletion of data from the Application 1 110 is performed by deleting only the allocation information of the corresponding file.

FIG. 7 illustrates file management that is performed by Application 2 120 through a file deletion method of the present invention.

According to the present invention, a file or data is deleted by adding a user system call 150 between the Application 2 120 and the kernel mode 170, in addition to the system call 140.

The Application 2 120 requests file deletion processing to the kernel mode 170 through the user system call 150.

In the file system 160 in the kernel mode 170, when a request for the file deletion processing is received through the user system call 150, the allocation information of the corresponding file in the FAT is deleted to delete data of the Application 2 120 (deletion of the file by changing an entry value of file information into deletion), a sector or a page in which data is stored, that is, a data area, is filled with a predetermined character, and then the data area allocated to the deleted file is reallocated as a re-usable area that is the corresponding area on which the next data can be written. Here, the predetermined character represents a null (ASCII code 0x00), and instead can include a specific character ‘F’ value or another character string.

In the kernel mode 170, a unique number (function number) is allocated for each function so that the individual system calls 140 are internally distinguished, and service routines corresponding to functions in the function table are defined inside the kernel by using the unique numbers as indexes.

In the kernel mode 170, a user system call 150 function is added to the function table, and a unique number (function number) is allocated for each function to distinguish the user system calls 150 when the file deletion processing is requested through the user system calls 150, and then a service routine corresponding to the user system call function in the function table is added using the unique number as an index.

In the kernel mode 170, the service routine corresponding to the user system call function is retrieved, and the file deletion processing is performed.

The service routine corresponding to the user system call function is to delete the allocation information in the FAT of the file and fill the data area with 0x00.

Hence, the allocation information is deleted, and a location at which the file is stored appears as an empty location.

In addition, even if the deleted file is attempted to be recovered through a recovery program, the files are impossible to restore since the data area is overwritten with the predetermined character (0x00).

As another embodiment, the service routine corresponding to the user system call function is to delete the allocation information in the FAT of the file, fill the data area with 0×00, and perform an operation to change the name of the file to be deleted.

For example, a filename of “from1942.wrk” is changed to “to1994.del”, thereby making it impossible to infer even a type and a purpose of file before deletion.

In the kernel mode 170, the system call 140 or the user system call 150 that corresponds to an access request to a file is detected from a program operated in the user mode 130.

In the present invention, when a file is selected in the Windows File Explorer in order to request the file system 160 for the file deletion, and then the “shift+del” keys are pressed in the kernel mode 170, the service routine corresponding to the system call function is retrieved and executed in the kernel mode 170, and when the “ctrl+del” keys are pressed, the service routine corresponding to the user system call function is retrieved and executed in the kernel mode 170.

In the kernel mode 170, when the “shift+del” keys are pressed, a request for the file deletion is received through the system call 140, allocation information of a corresponding file in the FAT is deleted to delete data of the Application 1 110 (deletion of the file by changing an entry value of file information into deletion) in the file system 160 in the kernel mode 170, and a data area allocated to the deleted file is reallocated as a re-usable area that is the corresponding area on which the next data can be written. The deletion of a file as described above enables the file to be restored and enables the file to be completely recovered by a file restoration program before data is written on the reallocated area.

In the kernel mode 170, when the “ctrl+del” keys are pressed, the request for the file deletion is received through the user system call 150, the allocation information of the corresponding file in the FAT is deleted to delete data of the Application 2 120 (deletion of the file by changing the entry value of the file information into deletion) in the file system 160 in the kernel mode 170, the sector or the page in which data is stored, that is, the data area, is filled with the null (ASCII code 0x00) or the specific character ‘F’ value, and then the data area allocated to the deleted file is reallocated as a re-usable area that is the corresponding area on which the next data can be written. In this manner, even if the file is recovered, a file filled with a specific string is recovered, thereby making it impossible to recover original data.

As shown in FIG. 8, when a right button on a mouse is clicked in the Windows File Explorer, the context menu 10 is activated, and a simple delete menu 20 for requesting file deletion through the system call 140 and a complete delete menu 30 for requesting file deletion through the user system call 150 are added to the activated context menu 10.

Here, the context menu 10 is a popup menu that appears when an item is clicked in a graphical user interface, and displays a list of various options depending on a menu retrieving operation, execution of an application program, or a status of a selected item.

The simple delete menu 20 allows simple deletion of a file to be performed by making the same interface call as when the “shift+del” keys are pressed, and the complete delete menu 30 allows complete deletion of a file to be performed by making the same interface call as when the “ctrl+del” keys are pressed.

In the operating system, the menus are activated by selecting an icon and then clicking the mouse right button thereon (long press on the icon on Android or iOS without a keyboard or mouse), and the file is completely deleted by using function selection of the menus through the method provided in the present invention.

Among applications, a scheduler plays a role in selecting one of processes that can be executed at the next execution time so that multiple processes can efficiently use limited memory.

The scheduler periodically checks a specific folder, and if there is a file, the scheduler deletes the file in the specific folder.

When the file is moved to the recycle bin, the scheduler completely deletes the file in the recycle bin at preset intervals through the complete deletion method of the present invention.

The complete deletion method of the present invention provides a function of enabling the file to be completely deleted even when the file is deleted in the same method as the existing simple deletion method in all application programs by adding the user system call function to the kernel mode 170 of the operating system or by providing the interface on which the corresponding user system call function is fulfilled.

Meanwhile, in the case of data such as text, the data is impossible to recover by performing overwriting overall, but in the case of a predetermined operating program, overwriting can be performed on a part of the operating program. In the case of the operating program, since it is difficult to restore the operating program even if only a part thereof is destroyed, the overwriting can be performed on a part thereof for efficiency.

The operation as described above can be performed by assigning a function of deleting the allocation information and a predetermined data overwriting function to the data deletion function of the operating system or can be performed by installing dedicated software.

In the case where the data is deleted in the manner described above, more time can be taken than in the existing deletion method, since the predetermined data such as a character needs to be recorded on the data or the file to be deleted. However, the data is completely deleted such that there is no need to concern of data leakage by a third party in the future.

Meanwhile, as described above, since a lot of time is taken to overwrite the deleted data area with other meaningless data, a significant delay can occur in operations of computers or smartphones. Hence, it is desirable to selectively make the deleted data irrecoverable.

In general, only a deletion function provided by a basic operating system on a computer or a smartphone, such as the Windows system for the computer or the Android or iOS system for a smartphone is used. As mentioned earlier, since this basic deletion function is used to delete only the allocation information of a file or data, there is a sufficient possibility of recovery of the file or data in the future.

Meanwhile, among the files or data to be deleted, there can be some that are relatively less important and do not matter if leaked externally, or there may be some important materials that must never be leaked externally.

In addition, in a case where an image file or a video file among the files or data is very large in size, a particularly long time is taken to delete data unrecoverably as proposed in the present invention. Therefore, it is necessary to selectively perform complete deletion depending on importance and a size of a file or data.

Hence, in the present invention, the complete deletion function is provided in the form of an auxiliary program in the case of the computer and in the form of an app in the case of the smartphone, in addition to the deletion function provided by the operating system of the computer or the smartphone.

When the deletion of a file or data is performed through the auxiliary program or the app, a message indicating the deletion of the allocation information for the file or the data, such as “simple deletion” 20, and a message indicating the complete deletion of the file or the data, such as “complete deletion” 30, will be displayed on a monitor or a screen, and a user clicks or touches a suitable item of the two messages to delete the message.

Hence, the user can unrecoverably or time-efficiently delete the file or the data that the user wants to delete.

Although the embodiments of the present invention have been described in detail above, the scope of the rights of the present invention is not limited thereto, and various modifications and improvements made by those skilled in the art by using the basic concept of the present invention defined in the following claims also fall within the scope of the rights of the present invention.

1. A method of unrecoverably deleting data stored in a sector of a hard disc or a page of a solid state drive (SSD), the method comprising:
deleting allocation information allocated to the data stored in the sector of the hard disc or the page of the SSD; and
overwriting a data area with a predetermined character.

2. The method of unrecoverably deleting data according to claim 1, wherein kernel mode includes a step of executing a simple deletion scheme of deleting allocation information of a file by receiving a request for file deletion processing through a system call from Application 1 which is an application program.

3. The method of unrecoverably deleting data according to claim 2, wherein the kernel mode further includes a step of adding a user system call for data deletion, deleting allocation information of a file by receiving a request for file deletion processing through the user system call from Application 2 which is an application program, and unrecoverably deleting the file by overwriting a data area with a predetermined character.

4. The method of unrecoverably deleting data according to claim 3, wherein the kernel mode further includes a step of filling the data area with a null (ASCII code 0x00) or a specific character ‘F’ value.

5. The method of unrecoverably deleting data according to claim 3, wherein the kernel mode further includes a step of changing a name of the file to be deleted.

6. A terminal device comprising:
user mode in which an application program is implemented;
kernel mode in which an operating system is implemented; and
hardware,
wherein, in the kernel mode, a simple deletion scheme of deleting allocation information of a file by receiving a request for file deletion processing through a system call from Application 1 which is an application program is executed, and
in the kernel mode, a complete deletion scheme of adding a user system call for data deletion, deleting allocation information of a file by receiving a request for file deletion processing through the user system call from Application 2 which is an application program, and unrecoverably deleting the file by overwriting a data area with a predetermined character is executed.

7. The terminal device according to claim 6, wherein, when a specific key is pressed in the kernel mode, file deletion is requested through the user system call, a file system in the kernel mode deletes allocation information in an FAT of the corresponding file to delete data of the Application 2, and filling the data area with a null (ASCII code 0x00) or a specific character ‘F’ value.

8. The terminal device according to claim 6, wherein the file deletion processing is configured of a form of the application programs in the case of a computer, and a form of applications in the case of a smartphone, and
when deletion is executed through the application programs or the applications, a first menu indicating the simple deletion scheme and a second menu indicating the complete deletion scheme are displayed as a context menu on a screen.

9. The terminal device according to claim 6, wherein, in the kernel mode, the complete deletion scheme is executed by deleting allocation information of a file by receiving a request for file deletion processing through the user system call from the Application 2, and unrecoverably deleting the file by changing a name of the file to be deleted.
